(19) United States
(12) Patent Application Publication
(10) Pub. No.: US 2020/0376885 A1
(43) Pub. Date: Dec. 3, 2020

(54) FRAME FOR MOUNTING A COVERING TO A CURVED WINDOW

(71) Applicant: Biggie Inc., Thousand Oaks, CA (US)

(72) Inventors: Ken MILHOUS, Thousand Oaks, CA (US); Michael KAST, Thousand Oaks, CA (US); Gordon HANDELSMAN, Thousand Oaks, CA (US)

(21) Appl. No.: 16/888,452

(22) Filed: May 29, 2020

Related U.S. Application Data
(60) Provisional application No. 62/854,590, filed on May 30, 2019.

(51) Int. Cl. B44C 1/165; B60J 1/20; B65C 9/06; B65C 9/25

(52) U.S. Cl. CPC B44C 1/165; B65C 9/25; B65C 9/06; B60J 1/20

(57) ABSTRACT

An apparatus, system, and method for applying a graphic or decal to a car window or other three-dimensional surface using a stretchable film and associated mounting frame is described. In some embodiments, a frame is mounted to the edge of a car window (or other target surface). The frame, which can be flexible or bendable, includes attachment points at various locations to facilitate attachment of a stretchable and/or shrinkable film to the frame. The film can include corresponding holes or other attachment openings, which generally align with the attachment points of the frame when the film is stretched (and/or shrunk) to conform to the shape of the frame (and, thus, the window).

### CROSS-REFERENCES TO RELATED APPLICATIONS

The present application claims the benefit of U.S. Provisional Application No. 62/854,590, filed on May 30, 2019, which is incorporated by reference in its entirety. This application is related to U.S. patent application Ser. No. 16/530,809, filed on Aug. 2, 2019.

### BACKGROUND

The present disclosure relates to mounting a covering, such as a graphic, decal, and/or other visual display, to a car or vehicle window.

Mounted graphics or decals include designs printed on substrates that can be mounted on surfaces. Mounted graphics include window graphics, which can be attached to windows, e.g., building windows, car windows (e.g., a decal covering the rear window of a car), and/or other curved windows.

In certain applications, a window graphic displays a pattern when viewed from one side of the window but is perceived as being effectively see-through or transparent from another side of the window. Creating a window graphic that displays an image, but also transmits light, can be accomplished, for example, by printing the image on one side of a substrate material and physically perforating the substrate material. When the perforated window graphic is attached to a window of a structure or vehicle, a person inside the structure or vehicle can see through the holes in the perforated substrate to the outside, thereby perceiving the window graphic as transparent.

On the other hand, a person outside the structure or vehicle may see the image printed on the outside surface of the substrate of the window graphic (e.g., the material remaining after perforation), without perceiving light through the holes.

The window graphic may be physically affixed to the window surface via an adhesive. The window graphic is attached to the window surface by coating the substrate with an adhesive and fixing the substrate to the window surface. The window graphic may also be covered with a laminate.

Typically, window graphics are generally installed by a professional or other skilled user to ensure that light transmission is not impeded and that the graphics are applied without bubbles or other imperfections. Because such installations often utilize professionals, they can be costly and inefficient, among other drawbacks.

### BRIEF DESCRIPTION OF THE DRAWINGS

Embodiments of the present technology will be described and explained through the use of the accompanying drawings.

FIG. 1 is a diagram illustrating a film attached to a frame mounted to a rear window of a car.

FIG. 2 is a diagram illustrating an example stretchable film.

FIGS. 3A-3C are diagrams illustrating example configurations of mounting frames.

FIG. 4 is a flow diagram illustrating a method of applying a graphic to a car window.

FIGS. 5A-5C are diagrams illustrating example components of a mounting frame.

FIG. 6 is a diagram illustrating a stretchable film attached to a mounting frame.

FIG. 7 is a diagram illustrating a stretchable film attached to a mounting frame having a capping component.

FIG. 8 is a diagram illustrating a stretchable film having a reinforced attachment edge.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

An apparatus, system, and method for applying a graphic, decal, or other covering to a car window or other three-dimensional surface using a stretchable and/or elastic film and associated mounting frame is described. In some embodiments, a frame is mounted to the edge of a car window (or other target surface). The frame, which can be flexible or bendable, includes attachment points at various locations to facilitate attachment of a stretchable film to the frame. The film can include corresponding holes or other attachment openings, which generally align with the attachment points of the frame when the film is stretched to conform to the shape of the frame (and, thus, the window).

Once the film is attached or fixed to the frame, the portion having the graphic or other visual display is applied to the window surface via a bonding or other adhering process. Attaching the film to the frame, enables an installer or user to fix the film in a shape that conforms to the shape of the window surface.

Thus, using the mounting frames described herein, an owner of a vehicle (or fleet of vehicles) can inexpensively apply graphics to the windows of the vehicles without compromising the quality or accuracy of the application of the graphics to the window surfaces. For example, the technology described herein can be provided to owners and other users via mounting kits that include a frame and a set of films to be applied to surfaces via the mounting frame. As another example, a professional installer can also utilize the disclosed technology, having different frames for different vehicles makes and models, and using the frames when customers request custom graphics for their vehicles.

While described herein with respect to a rear window of a car, in some embodiments aspects of the films and mounting frames described herein can be configured or utilized with other types of vehicles and/or structures that include three-dimensional surfaces onto which graphics, such as those described herein, can be mounted.

Various embodiments of the mounting frame and associated stretchable films will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

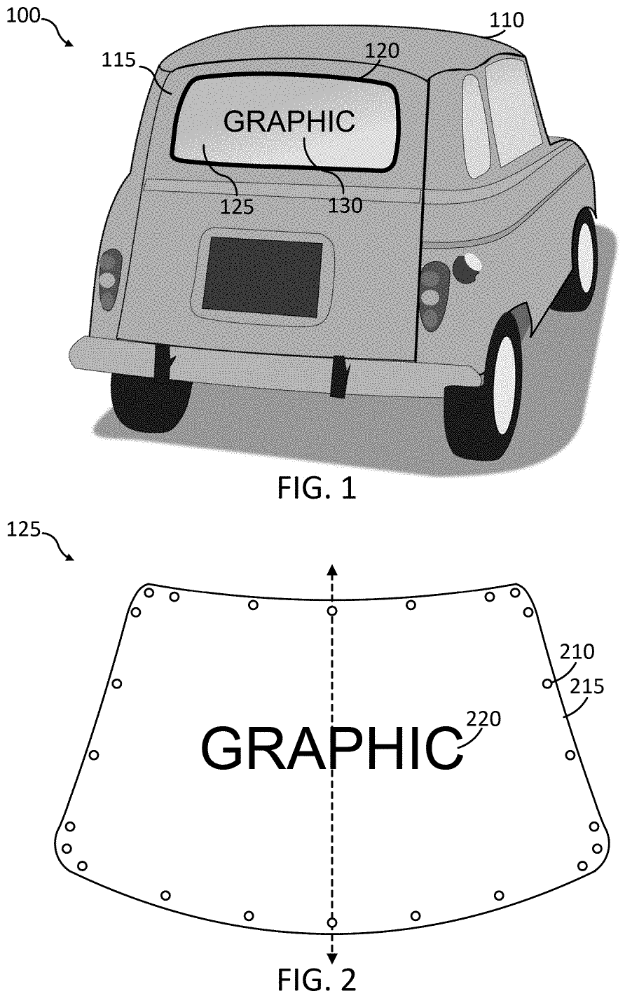

FIG. 1 is a diagram 100 illustrating a film attached to a frame mounted to a rear window of a car 110. The car 110 has a rear window 115 onto which a graphic 130 is to be affixed. For example, the graphic 130 can be a picture, image, advertisement, text, or any other visual display of information. As described herein, the graphic 130 can display a pattern or decal when viewed from one side of the window 115 (e.g., outside the car 110) but is perceived as seemingly transparent from another side of the window 115 (inside the car 110).

The graphic is on the surface of a stretchable film 125, which has been stretched and fixed or attached to a frame (e.g., a mounting frame) 120 that is mounted to the rear window 115 of the car 110. In such a configuration, the film 125 can be applied to the window 115 with few or no imperfections, despite the film 125 being a two-dimensional film and the window 115 having a three-dimensional surface onto which the film is applied.

In some cases, the window 115 (or other similar surfaces, such as windshields will have a curved surface (e.g., double curved), meaning that at any point on the curved surface, the surface curves in two orthogonal directions. When one is making a doubly curved surface or creating a covering for a doubly curved surface, there is a strong incentive to create the covering from a material that is initially flat, for example, for ease of manufacturing (cutting from flat stock) and/or ease of printing upon the surface. Thus, there is a need for rendering a doubly curved surface, or a close approximation of same, from a material that is initially flat.

A surface that is initially flat or that can be flattened to be planar is called a developable surface. A developable surface has a Gaussian curvature of zero at every point, because even if it is curved in one direction, the curvature in the direction orthogonal to the direction of maximum curvature is zero. The Gaussian curvature is an invariant of the surface, meaning that no matter how the surface may be deformed without stretching, its Gaussian curvature is always zero at every smooth point. Because a doubly curved surface has a non-zero Gaussian curvature at every point, it is not possible to smoothly deform a developable surface to conform exactly to a doubly curved surface, without stretching.

Thus, stretching a two-dimensional film, such as the film 125, to match the mounting frame 120 can enable the two-dimensional film to smoothly deform to the window surface. Further details regarding the matching of two-dimensional films or coverings to three-dimensional surfaces can be found in commonly-assigned application Ser. No. 16/530,809, filed on Aug. 2, 2019, which is incorporated by reference in its entirety.

FIG. 2 depicts an example stretchable film, such as film 125. The film 125 is a stretchable film, fabric, or covering, and can be elastic or non-elastic. Thus, the film 125 is formed of materials that facilitate the stretching and/or shrinking of the film at certain locations, such as near attachment points. As described herein, the material can be perforated, causing display of an opaque surface to viewers, while accommodating people inside a vehicle to see through the film to the outside of the vehicle.

As described herein, the film 125 is formed of materials, such as elastic materials or laminates, which can withstand stretching to a desirable shape while also having enough strength to shrink back into place once stretched (removing any sags or wrinkles due to the stretching movement of the material). In some cases, the elastic or stretchable film shrinks slightly after being stretched, in order to tightly conform to the surface being covered by the film 125. As an example, once stretched, heat and/or pressure (e.g., applied via tools) can be applied to portions of the film 125 that have been stretched, facilitating a shrinking movement to achieve the tight conformation to the surface.

Further, in some cases, the film 125 is sized slightly larger than the target window, and actions are performed (e.g., heat and/or pressure) to slightly shrink the film 125 to the approximate shape of the window (while being held in place by an associated frame or frame components).

In addition to various materials described herein for the film 125, the structure of the film can include one or multiple layers. For example, the film 125 can be a film laminate having three layers, including: (1) an optically clear top layer that provides protection for the other layers as well as mechanical strength for the film, (2) a middle layer having the printed graphic, pattern, or information display, and (3) a bottom layer that provides mechanical strength to the laminate (to prevent tearing during stretching) as well as support or carry a heat-activated adhesive used when bonding the laminate to the window.

As another example, the film 125 can be a film laminate having two layers, including: a top layer having the printed graphic, pattern, or information display and a bottom layer of clear elastic or stretchable material, which carries the adhesive (when the film is to be bonded to the surface) and facilitates the stretching/shrinking of the laminate.

The film 125 can be precut to shape prior to installation. Due to the complex curvature of the mounting surface, the film should stretch slightly in order to match the surface shape. Thus, a film substrate such as vinyl can be suitable for such applications, as only modest tension can elongate or stretch the film on the order of 0.025% to 2.5% (This is in contrast to film substrates such at PET, which cannot stretch under room temperature given modest applied tension).

The film 125 includes an attachment edge 215, having attachment points 210, such as reinforced holes or openings. The film 125 also includes a graphic 220 or pattern that is to be adhered or otherwise affixed to a window surface. As shown in FIG. 2, while the film 125 is two-dimensional, it has a shape that is symmetric about a vertical axis.

The film 125 can include multiple attachment points 210, such as 20 to 30 points, with multiple points located or positioned at the corners of the film 125. In some cases, the film 125 is stretched in directions extending outwards from the corners, and thus the placement of multiple attachment points 210 at the corners braces the stretched film from movement when attached to a mounting frame. However, in other cases the film can be stretched (or, primarily stretched) in other directions, and the mounting points 210 are positioned along the edge 215 proximate to the stretching locations or directions.

Thus, the film 125 can be stretched (and correspondingly shrunk) at many points or directions, in order to yield a smooth result. However, in some cases, a limited number of attachments points can mitigate excess stretching of the film, which can result in wrinkles or bunching of the film 125. For example, a simple installation ensuring a good fit can have about 20 or fewer attachment points 210. Placement of the attachment points 210 can be determined via templates, computer software, or other mechanisms.

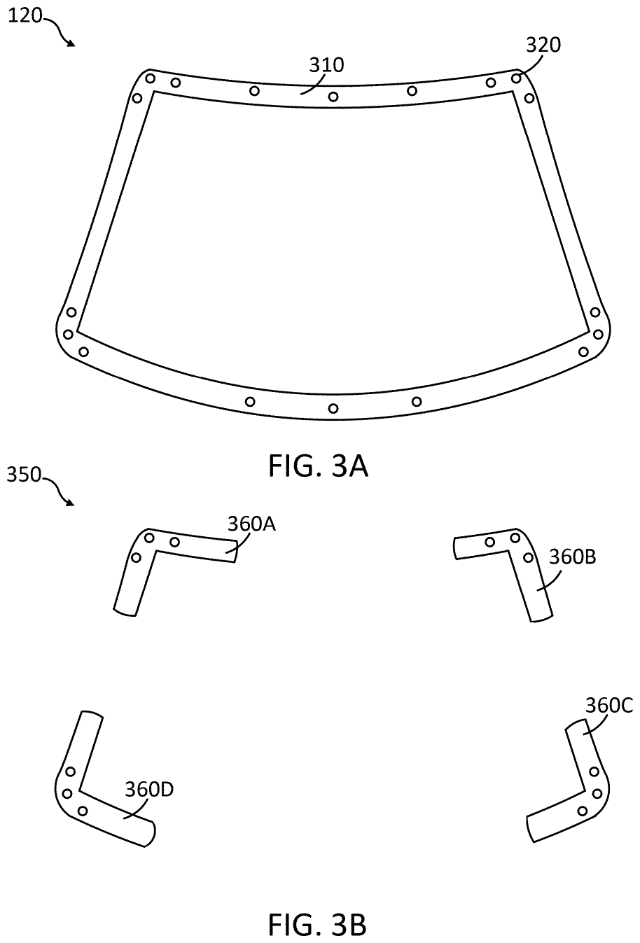

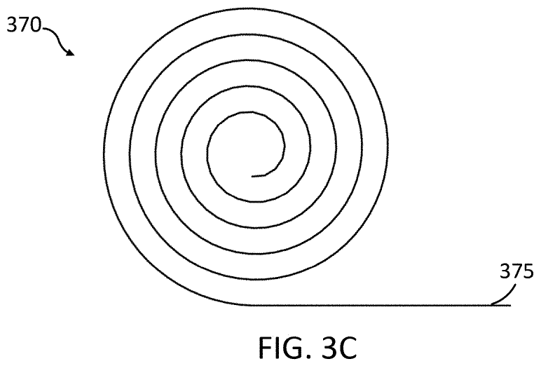

As described herein, the stretchable film 125, in some embodiments, is configured to match or align with a mounting frame, such as frame 120. For example, as shown in FIG. 3A, the mounting frame 120 can be a one-piece frame 310 having different mounting pins 320 or other attachment components. In some cases, the one-piece frame 310 can have a shape or geometry that matches a shape or geometry of a target surface, such as the rear window 115 of the car 110.

The one-piece frame 310 can have various mounting pins 320 disposed along the frame 310 at positions or locations that align with positions or locations of the attachment points 210 of the stretchable film 125. As is described herein, the pins 320 can be movable, and the configuration of pins 320 can be adjusted by a user when employing the frame 310 to mount the film 125.

As another example, shown in FIG. 3B, a mounting frame 350 can have multiple frame pieces or segments 360A-D that each mount to certain positions of a target surface, such as the corners of the rear window 115. Each of the segments 360A-D have mounting pins 320 or other attachment components and are positioned on the target surface to fix the stretchable film 125 at locations where the film is stretched. Thus, the mounting frame 350 includes two or more frame segments 360A-D positioned and mounted to the target surface at direction where the film 125 when attached to the frame 350.

In some cases, the mounting frame 120 is provided as a configurable component or piece without a pre-selected shape or geometry, allowing the user to configure the frame when employing during installations. FIG. 3C depicts such a mounting frame 370, which is a single piece of material 375 (rolled or coiled) that can be shaped or adapted when in use during an install. The user can cut the material 375 into pieces and can deform or shape the material to match the edge or perimeter of a target surface, such as a window or other three-dimensional surface. The frame 120 can be formed of various types of plastics or metals, and generally has a width that is ½ inch or smaller, enabling a sleek, unobtrusive installation to a window.

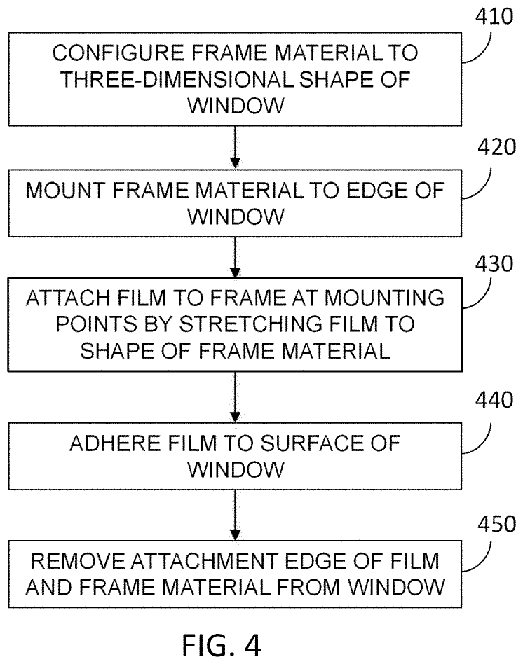

Thus, as described herein, the mounting frames 120 and/or stretchable film 125 or covering can be adapted or manufactured to align, at certain location, to simplify the installation and application of graphics to windows and other 3D surfaces. FIG. 4 is a flow diagram illustrating a method 400 of applying a graphic to a car window.

In step 410, the frame 120 or frame material is configured to match or approximate the three-dimensional shape of a target window, such as a rear car window. The frame 120 can be a one-piece frame (e.g., frame 120) having a geometry similar to a geometry for certain windows or surfaces (e.g., windows for a certain make and/or model of a vehicle). In some cases, the frame material can be provided as a coil or strip 370, and the installer transforms or modifies the material into a desired shape or configuration. Also, the frame 120 can be a collection of frame segments, such as segments 360A-D, having shapes that accommodate application at certain locations on the target window (e.g., where the film will be stretched).

In step 420, the mounting frame 120 is mounted to the target window or surface. The frame 120 can be mounted directly to the edge or perimeter of the window (such as a portion without an exposed edge) via an adhesive. In some cases (e.g., where there is an exposed edge), the frame 120 can include a clip or fastener (e.g., a mechanical “J” hook), and is mounted via the clip to the window or portion of the vehicle proximate to the window. Thus, a window having an exposed edge around an entire perimeter can accommodate use of a mechanical mounting clip and/or use of an adhesive to mount the frame 120 to the surface.

In step 430, the stretchable film 125 is positioned over the window and stretched in chosen directions (e.g., towards the corners or in a vertical direction on each side of the window) where it is attached to the frame at attachment or mounting points (where pins of the frame receive the holes or openings in the film 125). The stretching direction, in some cases, is determined based on the shape of the window. As described herein, the film 125 can be a pre-cut, perforated film that displays a graphic and includes an edge or perimeter of attachment points or openings.

In some embodiments, the window includes features disposed on or proximate to the window surface, such as a wiper. In order to accommodate such features, the film 125 is attached as described herein, and a slit is added to the film 125 at the location of the wiper or other feature (to avoid removing the wiper while attaching the film 125). Thus, even for windows having mounted wipers, the film 125 can attach to the frame in a manner that compensates for the wiper (e.g., by adding a slit to the film 125).

In step 440, once the film 125 is attached to the frame 120, the film conforms to the target surface. In some cases, the film 125 is conformed to the surface in an unbonded fashion (using pressure but without any adhesive). These cases can be implemented for temporary installations (e.g., a temporary advertisement), where durability of the covering is less of a factor.

However, in some cases, the film 125 is adhered to the surface via a bonding element, such as an adhesive. In such cases, the film 125 includes a layer or coating of a thermoplastic, thermally activated adhesive, or a pressure-sensitive adhesive and lubrication agent, as described herein. Once the film 125 is in position (attached to the frame 120 after being stretched and shrunk), low heat and pressure are applied to the film 125, forming a bond between the film 125 and the surface. Heat can also be applied to later remove the film 125.

In these cases, such as when durability and/or high optical performance is a factor, the use of the bonding element can ensure that the film 125 does not fail or otherwise get damaged during use (e.g., based on collecting dirt/dust, being in contact with wipers, and so on).

While in many cases the frame remains attached to the car window, in some embodiments, the user may wish to remove the frame after installation of the graphic. Thus, in step 450, the mounting frame 120 and attachment edge of the film 125 are optionally removed from the window. For example, after the main portion of the film 125, such as the graphic portion 220 of film 125, is bonded with the window, the attachment edge 215 of the film 125 can be removed by cutting or other mechanical actions (using a perforated edge). The frame 120 can then be unclipped or removed from the window, leaving the bonded graphic on the window.

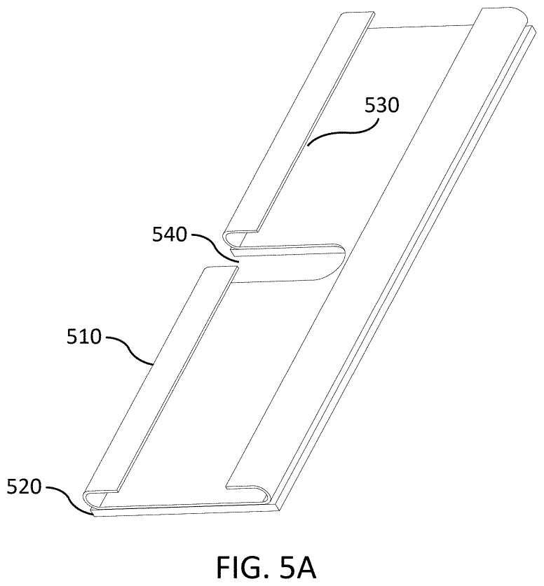

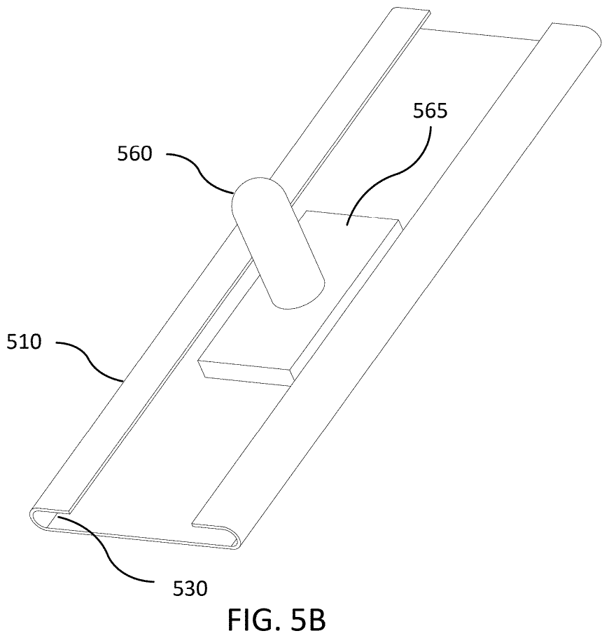

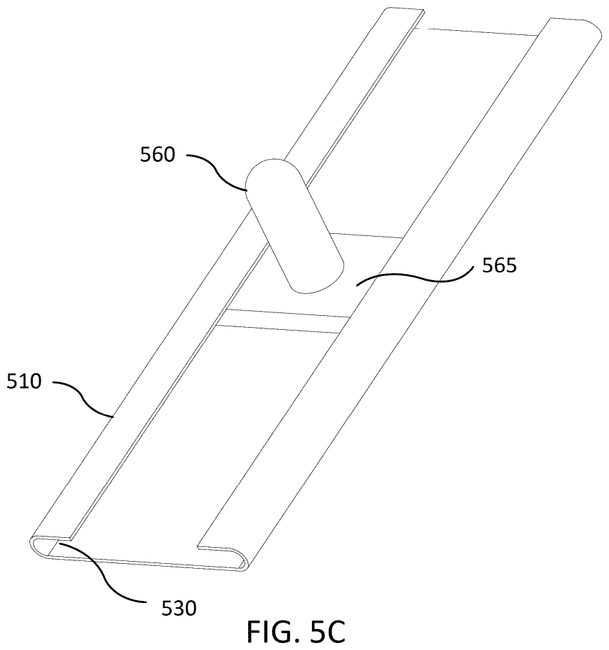

As described herein, the mounting frame 120 can be formed in a variety of configurations or pieces in order to accommodate a simple and flexible installation of the film 125 or covering to the target surface. FIGS. 5A-5C are diagrams illustrating example components of the mounting frame 120.

As depicted in FIG. 5A, a mounting frame 500 includes a bottom portion 510 or body of the frame, which mounts to the target surface via an adhesive 520 or mechanical clip (not shown). The body 510 of the frame 500 has a lip 530 or tab that accommodates the placement of pins or other attachment components along the body 510 of the frame 500. Further, the frame 500 can include indentions or cutouts 540, which enable the frame 500 to be bent or otherwise flexed when mounted to the target surface. These features can be pre-spaced along the frame at various locations or can be formed by a user during an installation.

FIGS. 5B and 5C depict the placement or fixing of a pin 560 or attachment component to the body 510 of the frame 500. As depicted, the pin 560 is disposed within the body 510 of the frame 500, such as partially within an opening or groove formed by the lip 530 of the frame 500. A pin lock 565 is then placed within the body 510 of the frame 500, such that it fits under the lip 530.

Once placed (see FIG. 5B), the pin lock 565 is rotated (see FIG. 5C), fixing the pin 560 to the position of the frame 500. Similarly, the pin lock 565 can be rotated back to remove the pin 560 from the frame 500, or to re-position the pin 560 along the frame 500. Thus, the frame 500 can accommodate the placement of multiple pins 560 along the frame 500, allowing for a flexible and configurable use of the frame 500 during different film installations, among other benefits.

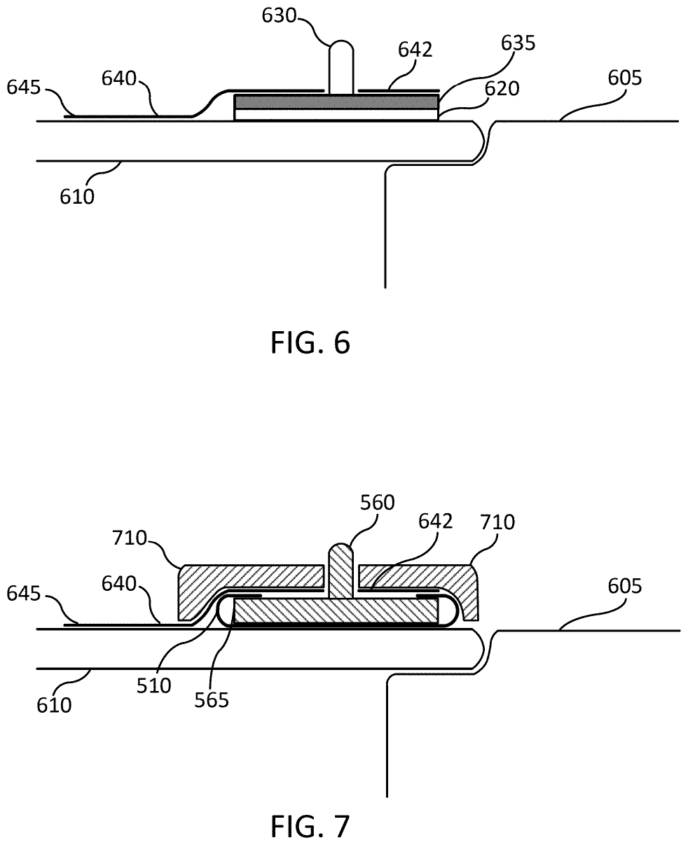

As described herein, the film 125, such as a perforated covering, is stretched to align its edge placed attachment points to the pins or other attachment components of the mounting frame 120. FIG. 6 is a diagram illustrating a stretchable film attached to a mounting frame. A glass window 610, proximate to a body 605 of a vehicle, receives a mounting frame 635 via an adhesive 620. The mounting frame 635 includes a pin 630 projecting vertically from the frame 635.

A stretchable film 640 is positioned over the glass window 610 and stretched in a direction of the pin 630. At the pin 630, and while stretched, an edge of the film 642, via an opening or attachment point, is placed over the pin 630, mating the pin 630 to the opening (the pin 630 projects through the opening, fixing the film 640 to the frame 635). Once fixed at the edge 642, an adhering portion 645 (e.g., the portion having a graphic or pattern or display) can be adhered to the window 610.

In some embodiments, the film 640 can move, even slightly, while fixed to a pin, such as pin 560 and/or pin 630. Such movement can result in small air gaps or imperfections between the film 640 and the glass window 610. To prevent such movement, the frame 510 as depicted in FIG. 7, can include a top portion or topping element 710 that attaches to pin 560, which fixes or secures the edge 642 of the film 640 during installation or conforming of the adhering portion 645.

The top portion 710, or cap or capping element, also facilitates the conforming of the film 640 to the window 610 near the frame 510 (and thus at the perimeter of the window 610). Thus, when capped, the film 640 can be bonded or otherwise pressed to the glass window 610, while the top portion 710 prevents the film from movement during the bonding or pressing process, among other benefits.

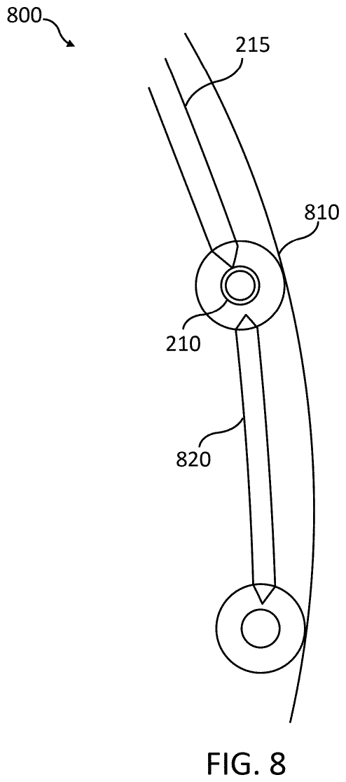

As described herein, the stretchable film 125 can include various stiffening or reinforcement components along its edge or perimeter that function to maintain the shape of the film 125 during the attachment to frames and/or the installation of graphics to surfaces. FIG. 8 is a diagram illustrating a stretchable film 800 having a reinforced attachment edge 215.

The edge 215 includes an opening or hole reinforcement 810, such as a small disc or donut-shaped component. The hole reinforcement 810 can prevent the material from tearing or deforming when attached to a pin of the mounting frame 120. Further, the edge 215 can include stiffeners or stiffening components 820, disposed between attachment points.

The stiffeners 820 can be disposed to maintain a desired shape of the edge 215 of the film 125 when attached to the frame 120, preventing pressured applied to the film 125 when attached to buckle or otherwise deform the film 125 between attachment points. Using these reinforcement components, an integrity of the shape of the film 125 is maintained during stretching and installation. Thus, the reinforcements can prevent, or at least mitigate imperfections arising in the film 125 during installation, among other benefits.

### Example Embodiments

As described herein, in some embodiments, a method of installing a graphic or other display of information to a vehicle window can include: mounting a three-dimensional frame to a perimeter of a three-dimensional glass surface of a vehicle; forming a two-dimensional perforated film having a displayable graphic, wherein the two-dimensional perforated film includes multiple attachment points positioned along an edge of the two-dimensional perforated film; wherein the two-dimensional perforated film has a shape that approximates (e.g., is similar to and/or sized the same or slightly larger) a shape of the three-dimensional frame mounted to the perimeter of the three-dimensional glass surface of the vehicle; attaching the two-dimensional perforated film to the three-dimensional frame via the multiple attachment points, wherein attaching the two-dimensional perforated film includes stretching the perforated film in multiple directions to align the multiple attachment points to corresponding attachment components of the three-dimensional frame; and causing the two-dimensional perforated film to adhere to the three-dimensional glass surface of the vehicle.

In some embodiments, the mounting frame can include a frame body having a portion configured to mount to an edge of the three-dimensional surface, wherein the frame body has a geometry that approximates a geometry of the edge of the three-dimensional surface; and multiple attachment pins disposed along the frame body, wherein the attachment pins are configured to fix the two-dimensional film to the three-dimensional surface via openings provided along an edge portion of the two-dimensional film.

In some embodiments, the frame and film can be part of an installation kit, which can include a three-dimensional frame configured to be mounted to an edge of the rear window and having a shape that approximates a shape of the rear window; and a two-dimensional perforated film that includes the graphic and attaches to the three-dimensional frame via multiple attachment points when stretched in multiple directions to align the multiple attachment points to corresponding attachment components of the three-dimensional frame.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A method, comprising:
mounting a three-dimensional frame to a perimeter of a three-dimensional glass surface of a vehicle;
forming a two-dimensional perforated film having a displayable graphic,
wherein the two-dimensional perforated film includes multiple attachment points positioned along an edge of the two-dimensional perforated film;
wherein the two-dimensional perforated film has a shape that approximates a shape of the three-dimensional frame mounted to the perimeter of the three-dimensional glass surface of the vehicle;
attaching the two-dimensional perforated film to the three-dimensional frame via the multiple attachment points,
wherein attaching the two-dimensional perforated film includes stretching the perforated film in multiple directions to align the multiple attachment points to corresponding attachment components of the three-dimensional frame; and
causing the two-dimensional perforated film to conform to the three-dimensional glass surface of the vehicle.

2. The method of claim 1, wherein the two-dimensional film is a film laminate including:
an optically clear top layer that protects the two-dimensional film;
a middle layer having the displayable graphic; and
a bottom elastic layer that provides mechanical strength to the two-dimensional film.

3. The method of claim 1, wherein causing the two-dimensional perforated film to conform to the three-dimensional glass surface of the vehicle includes:
causing the two-dimensional perforated film to shrink at locations proximate to the attachment points; and
bonding the two-dimensional perforated film to the three-dimensional glass surface by applying heat to a thermally activated adhesive coating of the two-dimensional perforated film.

4. The method of claim 1, wherein mounting a three-dimensional frame to a perimeter of a three-dimensional glass surface of a vehicle includes mounting a one-piece frame to an exposed portion of the glass surface via an adhesive disposed between the one-piece frame and the exposed portion of the glass surface.

5. The method of claim 1, wherein mounting a three-dimensional frame to a perimeter of a three-dimensional glass surface of a vehicle includes mounting a one-piece frame to the glass surface via one or more clips that mechanically fix the one-piece frame to the glass surface.

6. The method of claim 1, wherein mounting a three-dimensional frame to a perimeter of a three-dimensional glass surface of a vehicle includes mounting multiple frame components at positions along a perimeter of the three-dimensional glass surface where the stretching of the perforated film is directed.

7. The method of claim 1, wherein the attachment components of the three-dimensional frame that correspond to the multiple attachment points of the perforated film are pins that extend within openings of the multiple attachment points to attach the perforated film to the three-dimensional frame.

8. The method of claim 1, wherein the multiple attachment points of the two-dimensional perforated film include reinforced openings.

9. The method of claim 1, wherein the edge of the two-dimensional perforated film includes stiffeners positioned between the multiple attachment points.

10. The method of claim 1, wherein attaching the two-dimensional perforated film to the three-dimensional frame via the multiple attachment points includes:
attaching the multiple attachment points to pins of the three-dimensional frame; and
fixing caps to each of the pins to securely fix the perforated film to the three-dimensional frame.

11. An apparatus for adhering a two-dimensional film to a three-dimensional surface, the apparatus comprising:
a frame body having a portion configured to mount to an edge of the three-dimensional surface,
wherein the frame body has a geometry that approximates a geometry of the edge of the three-dimensional surface; and
multiple attachment pins disposed along the frame body,
wherein the attachment pins are configured to fix the two-dimensional film to the three-dimensional surface via openings provided along an edge portion of the two-dimensional film.

12. The apparatus of claim 11, further comprising:
multiple capping components that correspond to each of the multiple attachment pins and are disposed on top of the openings of the two-dimensional film to fix the two-dimensional film to the frame body.

13. The apparatus of claim 11, wherein the multiple attachment pins are removably fixed to the frame body via multiple pin locks that secure the multiple attachment pins to the frame body.

14. The apparatus of claim 11, wherein the multiple attachment pins are disposed at corners of the geometry of the frame body.

15. The apparatus of claim 11, wherein the frame body includes cutouts that facilitate flexing of the apparatus to match the geometry of the edge of the three-dimensional surface.

16. The apparatus of claim 11, wherein the portion configured to mount to an edge of the three-dimensional surface includes an adhesive that mounts the frame body to an exposed portion of the three-dimensional surface.

17. The apparatus of claim 11, wherein the portion configured to mount to an edge of the three-dimensional surface includes a mechanical clip that mounts the frame body to an edge of the three-dimensional surface.

18. The apparatus of claim 11, wherein the three-dimensional surface is a rear window of a car, and wherein the two-dimensional film includes a graphic to be applied to a surface of the rear window.

19. The apparatus of claim 11, wherein the attachment pins are configured to fix the two-dimensional film to the three-dimensional surface via openings provided along an edge portion of the two-dimensional film when the two-dimensional film is stretched in directions towards the attachment pins.

20. A graphic installation kit for installing a graphic to a rear window of an automobile, the graphic installation kit comprising:
a three-dimensional frame configured to be mounted to an edge of the rear window and having a shape that approximates a shape of the rear window; and
a two-dimensional elastic film that displays the graphic and attaches to the three-dimensional frame via multiple attachment points when stretched in multiple directions to align the multiple attachment points to corresponding attachment components of the three-dimensional frame.
